(19) United States
(12) Patent Application Publication
(10) Pub. No.: US 2020/0096776 A1
(43) Pub. Date: Mar. 26, 2020

(54) ADJUSTMENT DEVICE, DISPLAY SYSTEM, AND ADJUSTMENT METHOD

(71) Applicant: MITSUBISHI ELECTRIC CORPORATION, Tokyo (JP)

(72) Inventors: Yayoi HAYASHI, Tokyo (JP); Yuki FURUMOTO, Tokyo (JP)

(73) Assignee: MITSUBISHI ELECTRIC CORPORATION, Tokyo (JP)

(21) Appl. No.: 16/495,060

(22) PCT Filed: May 1, 2017
(86) PCT No.: PCT/JP2017/017161

§ 371 Date: Sep. 17, 2019

(51) Int. Cl. G02B 27/01; G09G 5/38; G06K 9/00; B60K 35/00; B60R 1/00; G01S 13/931

(52) U.S. Cl. CPC G02B 27/0179; G01S 2013/9324; G06K 9/00805; G02B 27/0101; B60K 35/00; B60R 1/00; G01S 13/931; G09G 2360/14; G09G 2354/00; G09G 2380/10; G09G 2320/0693; G02B 2027/0134; G02B 2027/014; G02B 2027/0185; B60K 2370/1529; B60K 2370/151; B60K 2370/21; B60K 2370/349; B60K 2370/179; B60R 2300/205; B60R 2300/402; G09G 5/38

(57) ABSTRACT

A position of a virtual image corresponding to a display image in a view outside a vehicle is adjusted by adjustment of the display image. An adjustment device includes an adjustment unit for performing adjustment of the display image depending on operation input to an operation input device in a state where reference light, serving as a reference for the position of the virtual image, is emitted to a road surface, and an adjustment condition determining unit for detecting an adjustable distance range, in which the adjustment can be performed, in an adjustment target distance range set to be subjected to the adjustment, in which the adjustment unit performs the adjustment of the display image corresponding to the virtual image in the adjustable distance range in a state where the reference light is emitted to a road surface in the adjustable distance range.

### TECHNICAL FIELD

The present invention relates to a display system for vehicles and an adjustment device and an adjustment method for the display system.

### BACKGROUND ART

In the related art, in-vehicle transmissive display devices are developed. For example, so-called “head-up displays (HUDs)” have been developed which displays an image by projecting the image on a windshield of a vehicle or a combiner arranged to face the windshield. Also developed are HUDs that enable stereoscopic vision based on binocular parallax by displaying an image for the left eye and an image for the right eye.

Hereinafter, an image generated by a transmissive display device is referred to as a “display image”. A surface of a windshield or a combiner on which a display image is projected is referred to as a “projection plane”. A passenger of a vehicle visually recognizes a view outside the vehicle (hereinafter referred to as “the outside view”) through the projection plane and perceives a display image as a virtual image arranged in the outside view.

Here, it is desirable that the position of the virtual image in the outside view is a predetermined position corresponding to the distance to an object indicated by the display image corresponding to the virtual image. For example, it is desirable that a virtual image corresponding to a display image for guiding an intersection located 50 m ahead of the vehicle is perceived as being located 50 m ahead of the vehicle.

However, the position of a virtual image in the outside view varies depending on the position of the passenger's eyes. In addition, in the case of a HUD for stereoscopic vision, the position of a virtual image in the outside view varies depending on various factors such as the width between a passenger's eyes, surrounding brightness, and the color of a display image. When the position of the virtual image in the outside view is different from a predetermined position, the passenger of the vehicle may feel discomfort with the display of the HUD. Therefore, a technology has been developed which brings the position of a virtual image in the outside view closer to a predetermined position by adjusting the position or the size of the display image on the projection plane (so-called “calibration”).

For example in a display system (100) of Patent Literature 1, a camera (3) provided in a vehicle (Ve) generates a front image (Im), and a display (44) of a navigation device (1) displays the front image (Im). A head-up display (2) further displays a marker image (Mk) on a combiner (9). A driver of the vehicle (Ve) uses a touch panel (61) to input the position corresponding to the marker image (Mk) in the front image (Im). A control unit (55) adjusts the display position and the magnification ratio of a virtual image (Iv) in the combiner (9) on the basis of the input position.

### CITATION LIST

### Patent Literature

Patent Literature 1: JP 2015-182672 A

### SUMMARY OF INVENTION

### Technical Problem

The display system of Patent Literature 1 allows a driver of the vehicle to input the position corresponding to the marker image using the touch panel at the time of calibration while comparing the outside view and the display of the navigation device. For this reason, there is a disadvantage that the position of the marker image and the input position are likely to be shifted, and thus the accuracy of calibration is low.

On the other hand, as a new method which is not disclosed in Patent Literature 1, a method for performing calibration using a lighting device mounted to a vehicle is conceivable. That is, this lighting device emits light (hereinafter referred to as “reference light”) which serves as a reference for the position of a virtual image to a road surface. A passenger of the vehicle performs calibration such that the position of the virtual image approaches the position indicated by the reference light while visually recognizing the reference light and the virtual image with the reference light emitted to the road surface. This allows the accuracy of calibration to be improved as compared with the display system of Patent Literature 1.

However, the method of performing calibration using the reference light has a disadvantage that calibration cannot be normally performed in situations like the following. For example, it is assumed that a range of 10 to 50 meters (m) ahead of the vehicle is calibrated at intervals of 10 m. In this case, it is required to emit reference light to the road surfaces 10 m, 20 m, 30 m, 40 m, and 50 m ahead of the vehicle. However, in a case where there is a wall-like obstacle 25 m ahead of the vehicle in the above case, reference light corresponding to each distance of 30 m, 40 m, and 50 m is emitted not on the road surface but on the obstacle. As a result, the position of the reference light corresponding to each of these distances deviates from the normal position, and thus calibration cannot be performed normally.

The present invention has been made to solve the disadvantages as described above, and an object of the present invention is to, in a method of performing calibration using reference light, perform calibration within a range in which calibration can be normally performed.

### Solution to Problem

In an adjustment device according to the present invention, a position of a virtual image corresponding to a display image in a view outside a vehicle is adjusted by adjustment of the display image by an in-vehicle transmissive display device, the adjustment device including: an adjustment unit for performing adjustment of the display image depending on operation input to an operation input device in a state where reference light, serving as a reference for the position of the virtual image, is emitted to a road surface; and an adjustment condition determining unit for detecting an adjustable distance range, in which the adjustment can be performed, in an adjustment target distance range set to be subjected to the adjustment, in which the adjustment unit performs the adjustment of the display image corresponding to the virtual image in the adjustable distance range in a state where the reference light is emitted to a road surface in the adjustable distance range.

### Advantageous Effects of Invention

According to the present invention, with the aforementioned configuration, in a method of performing calibration using reference light, calibration can be performed within a range in which calibration can be normally performed.

### BRIEF DESCRIPTION OF DRAWINGS

FIG. 1 is an explanatory diagram which is a combination of a functional block diagram illustrating a main part of an adjustment device according to a first embodiment of the present invention and a system configuration diagram illustrating a main part of a display system including the adjustment device.

FIG. 2A is a hardware configuration diagram illustrating a main part of a control device and a storage device included in the display system according to the first embodiment of the present invention. FIG. 2B is another hardware configuration diagram illustrating a main part of the control device and the storage device included in the display system according to the first embodiment of the present invention.

FIG. 3 is a flowchart illustrating the operation of the adjustment device according to the first embodiment of the present invention.

FIG. 4 is an explanatory diagram illustrating a positional relationship between a vehicle and an obstacle.

FIG. 5 is an explanatory diagram illustrating a positional relationship of a vehicle, an obstacle, reference light, and a virtual image.

FIG. 6A is an explanatory diagram illustrating a state in which the obstacle, reference light, and a virtual image before adjustment are viewed from inside the vehicle. FIG. 6B is an explanatory diagram illustrating a state in which the obstacle, the reference light, and a virtual image after adjustment are viewed from inside the vehicle.

FIG. 7 is a flowchart illustrating other operation of the adjustment device according to the first embodiment of the present invention.

FIG. 8 is an explanatory diagram which is a combination of a functional block diagram illustrating a main part of an adjustment device according to a second embodiment of the present invention and a system configuration diagram illustrating a main part of a display system including the adjustment device.

FIG. 9 is a flowchart illustrating the operation of the adjustment device according to the second embodiment of the present invention.

FIG. 10 is an explanatory diagram illustrating an example of a first image displayed on a display device.

FIG. 11 is an explanatory diagram which is a combination of a functional block diagram illustrating a main part of another adjustment device according to the second embodiment of the present invention and a system configuration diagram illustrating a main part of a display system including the other adjustment device.

FIG. 12 is a flowchart illustrating the operation of the other adjustment device according to the second embodiment of the present invention.

FIG. 13 is an explanatory diagram which is a combination of a functional block diagram illustrating a main part of an adjustment device according to a third embodiment of the present invention and a system configuration diagram illustrating a main part of a display system including the adjustment device.

FIG. 14 is a flowchart illustrating the operation of the adjustment device according to the third embodiment of the present invention.

FIG. 15 is an explanatory diagram illustrating an example of a second image displayed on a display device.

FIG. 16 is an explanatory diagram which is a combination of a functional block diagram illustrating a main part of another adjustment device according to the third embodiment of the present invention and a system configuration diagram illustrating a main part of a display system including the other adjustment device.

FIG. 17 is an explanatory diagram which is a combination of a functional block diagram illustrating a main part of still another adjustment device according to the third embodiment of the present invention and a system configuration diagram illustrating a main part of a display system including the adjustment device.

FIG. 18 is an explanatory diagram which is a combination of a functional block diagram illustrating a main part of yet another adjustment device according to the third embodiment of the present invention and a system configuration diagram illustrating a main part of a display system including the adjustment device.

FIG. 19 is a flowchart illustrating the operation of the adjustment device illustrated in FIG. 18.

FIG. 20 is a flowchart illustrating other operation of the adjustment device illustrated in FIG. 18.

### DESCRIPTION OF EMBODIMENTS

To describe the present invention further in detail, embodiments for carrying out the present invention will be described below with reference to accompanying drawings.

### First Embodiment

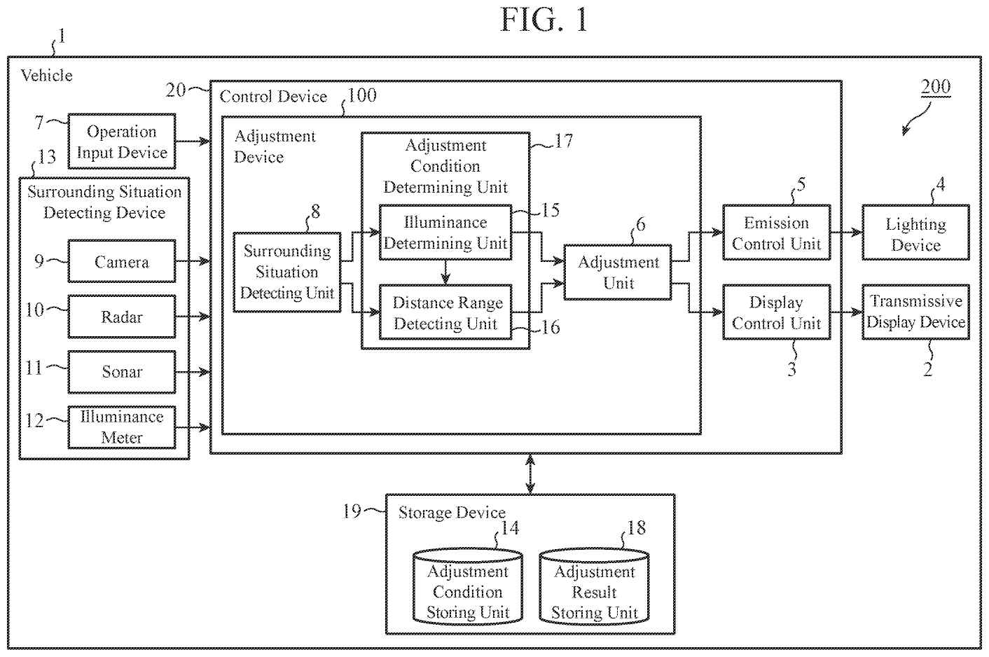

FIG. 1 is an explanatory diagram which is a combination of a functional block diagram illustrating a main part of an adjustment device according to a first embodiment of the present invention and a system configuration diagram illustrating a main part of a display system including the adjustment device. An adjustment device 100 of the first embodiment and a display system 200 including the adjustment device 100 will be described with reference to FIG. 1. Note that the display system 200 is mounted to a vehicle 1 as illustrated in FIG. 1.

A transmissive display device 2 includes, for example, a HUD for stereoscopic vision. That is, the transmissive display device 2 displays an image for the left eye and an image for the right eye by projecting these images on the windshield of the vehicle 1 or a combiner arranged to face the windshield. Stereoscopic vision based on binocular parallax is formed when a passenger of the vehicle 1 visually recognizes the image for the left eye and the image for the right eye.

Hereinafter, an image generated by the transmissive display device 2 is referred to as a “display image”. A surface of a windshield or a combiner on which a display image is projected is referred to as a “projection plane”. A passenger on the vehicle 1 visually recognizes the outside view through the projection plane and perceives a display image as a virtual image arranged in the outside view.

A display control unit 3 executes control to cause the transmissive display device 2 to display a display image for adjustment. A display image for adjustment is, for example, an arrow-shaped image. The display control unit 3 controls the transmissive display device 2 such that the arrow-shaped virtual image is visually recognized by the passenger as being on a road surface ahead of the vehicle 1.

A lighting device 4 includes, for example, a light source such as a light emitting diode (LED) or a laser diode (LD). The lighting device 4 emits reference light for the position of a virtual image on the road surface. Specifically, for example, the lighting device 4 is integrated with a headlamp of the vehicle 1 and emits linear reference light on a road surface ahead of the vehicle 1.

An emission control unit 5 executes control to cause the lighting device 4 to emit reference light.

An adjustment unit 6 instructs the emission control unit 5 to emit reference light and instructs the display control unit 3 to display a display image for adjustment. The adjustment unit 6 performs adjustment of the display image depending on the operation input to an operation input device 7 in a state where the reference light is emitted to the road surface and the display image for adjustment is displayed on the projection plane.

Specifically, for example, the adjustment unit 6 adjusts at least one of the position, the size, the binocular parallax, and the brightness of the display image on the projection plane. The adjustment of the display image by the adjustment unit 6 is to bring the position of the virtual image in the outside view closer to a position indicated by the reference light. Hereinafter, adjustment of the display image by the adjustment unit 6 is simply referred to as “adjustment” in some cases.

The operation input device 7 accepts input of operation by a passenger of the vehicle 1, that is, a user of the display system 200. The operation input device 7 includes, for example, a touch panel included in a navigation device (not illustrated) mounted to the vehicle 1.

A surrounding situation detecting unit 8 detects the surrounding situation of the vehicle 1 (hereinafter, simply referred to as a “surrounding situation” in some cases). Specifically, for example, the surrounding situation detecting unit 8 detects an obstacle present ahead of the vehicle 1 and also detects undulations on the road surface ahead of the vehicle 1 by using at least one of a camera 9, a radar 10, and sonar 11 provided in the vehicle 1. The surrounding situation detecting unit 8 detects the illuminance around the vehicle 1 by using an illuminance meter 12 provided in the vehicle 1. A surrounding situation detecting device 13 is composed of the camera 9, the radar 10, the sonar 11 and the illuminance meter 12. The surrounding situation detecting unit 8 outputs the detection result of the obstacle and the undulations to a distance range detecting unit 16 and also outputs the detection result of the illuminance to an illuminance determining unit 15.

The adjustment condition storing unit 14 stores in advance conditions for the adjustment unit 6 to perform adjustment (hereinafter referred to as “adjustment conditions”). The adjustment conditions include, for example, the following first condition, second condition, and third condition.

The first condition is to perform adjustment in an environment within a predetermined illuminance range (hereinafter referred to as “adjustable illuminance range”). The adjustable illuminance range is set to a range in which adjustment by the adjustment unit 6 can be normally performed depending on the light emission amount of the lighting device 4 and an upper limit value and a lower limit value of the brightness of a display image.

That is, when the illuminance around the vehicle 1 is too high, it becomes difficult to visually recognize the reference light and a display image for adjustment, and thus it is difficult to perform adjustment normally. On the other hand, when the illuminance around the vehicle 1 is too low, it becomes difficult to form a display image with binocular parallax, and thus it is difficult to perform adjustment normally. Therefore, setting the adjustable illuminance range to an appropriate range allows adjustment to be performed in an illuminance environment where the adjustment can be normally performed.

The second condition is to perform adjustment over a predetermined distance range (hereinafter referred to as “adjustment target distance range”). That is, the adjustment target distance range is a distance range set as a target of adjustment by the adjustment unit 6. The adjustment target distance range is, for example, set to a range of 10 to 50 meters (m) ahead of the position of the eyes of the passenger of the vehicle 1, that is, the position of the eyes of the user of the display system 200 (hereinafter referred to as “eye position”).

The third condition is to perform adjustment at each predetermined distance interval (hereinafter referred to as “adjustment target distance interval”). That is, the adjustment target distance interval is a distance interval set as an adjustment target by the adjustment unit 6. The adjustment target distance interval is set to, for example, an interval of 10 m based on the eye position.

The illuminance determining unit 15 determines whether a value of the illuminance detected by the surrounding situation detecting unit 8 (hereinafter referred to as “detected illuminance”) is within the adjustable illuminance range by using the detection result of the illuminance by the surrounding situation detecting unit 8 and the first condition of the adjustment conditions stored in the adjustment condition storing unit 14. The illuminance determining unit 15 outputs the determination result to the adjustment unit 6 and the distance range detecting unit 16. The illuminance determining unit 15 also outputs the value of the detected illuminance to the adjustment unit 6 when having determined that the value of the detected illuminance is within the adjustable illuminance range.

When the illuminance determining unit 15 determines that the value of the detected illuminance is within the adjustable illuminance range, the distance range detecting unit 16 detects a distance range in which adjustment can be normally performed (hereinafter referred to as “adjustable distance range”) out of the adjustment target distance range by using the detection result of the obstacle and undulations by the surrounding situation detecting unit 8 and the second condition among the adjustment conditions stored in the adjustment condition storing unit 14. The distance range detecting unit 16 outputs the detected adjustable distance range to the adjustment unit 6.

Specifically, for example, the distance range detecting unit 16 detects, as the adjustable distance range, a distance range in which the reference light is not emitted to the obstacle or the road surface having undulations and the virtual image corresponding to the display image for adjustment is not superimposed on the obstacle and the road surface having undulations. In other words, the distance range detecting unit 16 detects, as the adjustable distance range, a distance range in which the reference light is emitted on a substantially flat road surface and the virtual image corresponding to the display image for adjustment is superimposed on the substantially flat road surface.

An adjustment condition determining unit 17 is composed of the illuminance determining unit 15 and the distance range detecting unit 16.

Meanwhile, the adjustment unit 6 performs the adjustment when the illuminance determining unit 15 determines that the value of the detected illuminance is within the adjustable illuminance range. That is, the adjustment unit 6 cancels execution of adjustment when the illuminance determining unit 15 determines that the value of the detected illuminance is outside the adjustable illuminance range.

When performing adjustment, the adjustment unit 6 performs the adjustment of the display image corresponding to the virtual image within the adjustable distance range. That is, the adjustment unit 6 does not perform adjustment of a display image corresponding to a virtual image outside the adjustable distance range. In this case, using the third condition among the adjustment conditions stored in the adjustment condition storing unit 14, the adjustment unit 6 performs adjustment for each adjustment target distance interval.

Furthermore, when adjustment has been performed, the adjustment unit 6 outputs, to an adjustment result storing unit 18, the value of the illuminance around the vehicle 1 when the adjustment has been performed (that is, the value of the detected illuminance input from the illuminance determining unit 15), the value of each distance at which the adjustment has been performed, and an adjustment result corresponding to each of the distances. The adjustment result storing unit 18 stores the value of the illuminance, the values of the distances, and the adjustment results input from the adjustment unit 6. A storage device 19 is composed of the adjustment condition storing unit 14 and the adjustment result storing unit 18.

The adjustment device 100 is composed of the surrounding situation detecting unit 8, the adjustment condition determining unit 17, and the adjustment unit 6. A control device 20 is composed of the adjustment device 100, the emission control unit 5, and the display control unit 3. The display system 200 is composed of the operation input device 7, the surrounding situation detecting device 13, the control device 20, the storage device 19, the lighting device 4, and the transmissive display device 2.

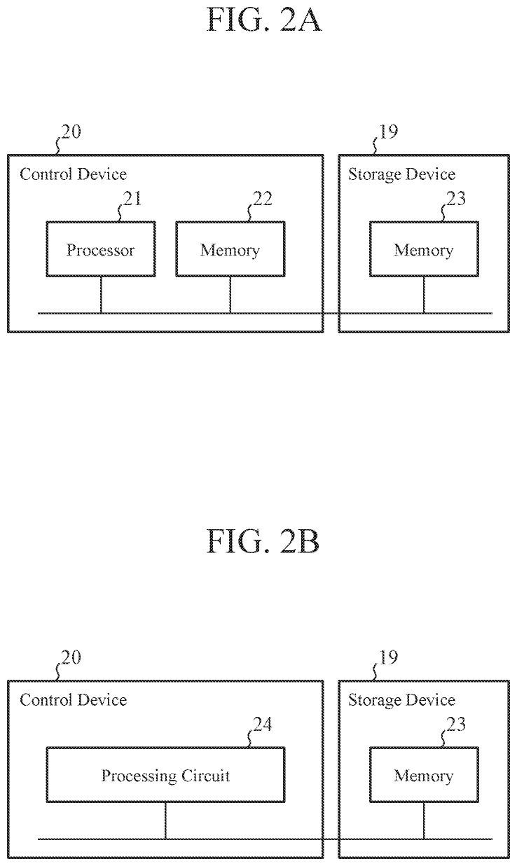

Next, hardware configurations of the control device 20 and the storage device 19 will be described with reference to FIG. 2. As illustrated in FIG. 2A, the control device 20 includes a computer, including a processor 21 and a memory 22. The memory 22 stores programs for causing the computer to function as the surrounding situation detecting unit 8, the illuminance determining unit 15, the distance range detecting unit 16, the adjustment unit 6, the emission control unit 5, and the display control unit 3 illustrated in FIG. 1. Reading and executing the programs stored in the memory 22 by the processor 21 results in implementation of the functions of the surrounding situation detecting unit 8, the illuminance determining unit 15, the distance range detecting unit 16, the adjustment unit 6, the emission control unit 5, and the display control unit 3. The functions of the adjustment condition storing unit 14 and the adjustment result storing unit 18 illustrated in FIG. 1 are implemented by a memory 23.

The processor 21 includes, for example, a central processing unit (CPU), a graphics processing unit (GPU), a microprocessor, a micro controller, a digital signal processor (DSP), or the like. The memory 22 includes a semiconductor memory such as a random access memory (RAM), a read only memory (ROM), a flash memory, an erasable programmable read only memory (EPROM), or an electrically erasable programmable read-only memory (EEPROM). The memory 23 includes, for example, a semiconductor memory similar to the memory 22, a magnetic disk, an optical disk, a magneto-optical disk, or the like.

Alternatively, as illustrated in FIG. 2B, the functions of the surrounding situation detecting unit 8, the illuminance determining unit 15, the distance range detecting unit 16, the adjustment unit 6, the emission control unit 5, and the display control unit 3 may be implemented by a dedicated processing circuit 24. The processing circuit 24 may be, for example, an application specific integrated circuit (ASIC), a programmable logic device (PLD), a field-programmable gate array (FPGA), a system-on-a-chip (SoC), a system large-scale integration (LSI), or a combination thereof.

Note that the functions of the surrounding situation detecting unit 8, the illuminance determining unit 15, the distance range detecting unit 16, the adjustment unit 6, the emission control unit 5, and the display control unit 3 may be separately implemented by the processing circuit 24, or the functions of the respective units may be collectively implemented by the processing circuit 24. Alternatively, some of the functions of the surrounding situation detecting unit 8, the illuminance determining unit 15, the distance range detecting unit 16, the adjustment unit 6, the emission control unit 5, and the display control unit 3 may be implemented by the processor 21 and the memory 22 illustrated in FIG. 2A, and the rest of the functions may be implemented by the processing circuit 24 illustrated in FIG. 2B.

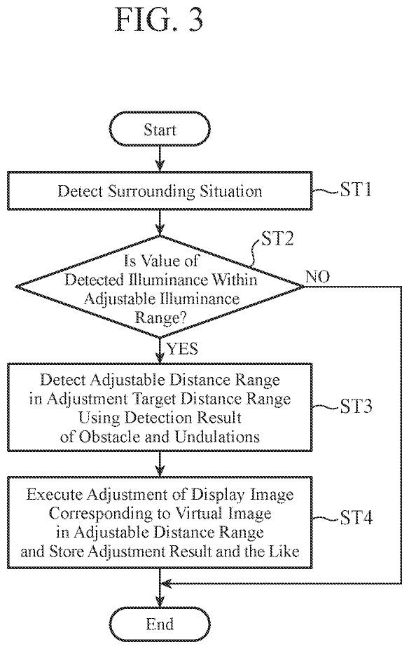

Next, the operation of the adjustment device 100 will be described with reference to a flowchart of FIG. 3. Note that adjustment conditions are prestored in the adjustment condition storing unit 14. When operation indicating the start of adjustment is input to the operation input device 7, the adjustment device 100 starts processing of step ST1.

First, in step ST1, the surrounding situation detecting unit 8 detects the surrounding situation of the vehicle 1. That is, the surrounding situation detecting unit 8 detects an obstacle present ahead of the vehicle 1 and also detects undulations on a road surface ahead of the vehicle 1 by using at least one of the camera 9, the radar 10, and the sonar 11 provided in the vehicle 1. The surrounding situation detecting unit 8 further detects the illuminance around the vehicle 1 by using the illuminance meter 12 provided in the vehicle 1. The surrounding situation detecting unit 8 outputs the detection result of the obstacle and the undulations to the distance range detecting unit 16 and also outputs the detection result of the illuminance to the illuminance determining unit 15.

Next, in step ST2, the illuminance determining unit 15 determines whether the value of the detected illuminance in step ST1 is within the adjustable illuminance range by using the detection result of the illuminance in step ST1 and the first condition among the adjustment conditions stored in the adjustment condition storing unit 14. The illuminance determining unit 15 outputs the determination result to the adjustment unit 6 and the distance range detecting unit 16. If it is determined that the value of the detected illuminance is within the adjustable illuminance range (“YES” in step ST2), the illuminance determining unit 15 outputs the value of the detected illuminance to the adjustment unit 6.

If it is determined that the value of the detected illuminance is outside the adjustable illuminance range (“NO” in step ST2), the adjustment unit 6 cancels execution of the adjustment. Thus, the processing of the adjustment device 100 completes.

On the other hand, if it is determined that the value of the detected illuminance is within the adjustable illuminance range (“YES” in step ST2), in step ST3, the distance range detecting unit 16 detects an adjustable distance range out of the adjustment target distance range by using the detection result of the obstacle and the undulations in step ST1 and the second condition among the adjustment conditions stored in the adjustment condition storing unit 14. Specifically, for example, the distance range detecting unit 16 detects, as the adjustable distance range, a distance range in which the reference light is emitted on a substantially flat road surface and a virtual image corresponding to a display image for adjustment is superimposed on the substantially flat road surface. The distance range detecting unit 16 outputs the detected adjustable distance range to the adjustment unit 6.

Next, in step ST4, the adjustment unit 6 instructs the emission control unit 5 to emit the reference light and instructs the display control unit 3 to display a display image for adjustment. The adjustment unit 6 performs adjustment of the display image depending on the operation input to the operation input device 7 in a state where the reference light is emitted to the road surface and the display image for adjustment is displayed on the projection plane.

At this time, the adjustment unit 6 performs adjustment of the display image corresponding to the virtual image within the adjustable distance range detected in step ST3. Furthermore, the adjustment unit 6 performs adjustment for each adjustment target distance interval by using the third condition among the adjustment conditions stored in the adjustment condition storing unit 14. When operation indicating the end of the adjustment is input to the operation input device 7, the adjustment unit 6 causes the adjustment result storing unit 18 to store the value of the illuminance around the vehicle 1 when the adjustment has been performed (that is, the value of the detected illuminance input from the illuminance determining unit 15 in step ST2), the value of each distance at which the adjustment has been performed, and an adjustment result corresponding to each of the distances. Thus, the processing of the adjustment device 100 completes.

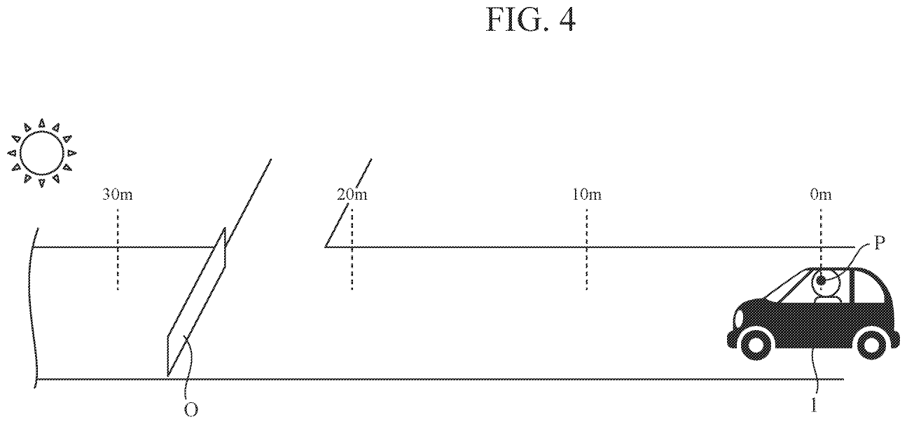

Next, a specific example of adjustment by the adjustment unit 6 will be described with reference to FIGS. 4 to 6.

For the vehicle 1 illustrated in FIG. 4, let us assume that the value of the illuminance detected by the surrounding situation detecting unit 8 is within the adjustable illuminance range.

In this example, a wall-shaped obstacle O is present at a position 25 m ahead of an eye position P. In this case, in a partial distance range (25 to 50 m) out of a detection target distance range (10 to 50 m), the reference light is emitted to the obstacle O when the lighting device 4 emits the reference light, and a virtual image is superimposed on the obstacle O when the transmissive display device 2 displays the display image for adjustment. On the other hand, in the remaining distance range (10 to 25 m) of the detection target distance range (10 to 50 m), the reference light is emitted to a substantially flat road surface when the lighting device 4 emits the reference light, and the virtual image is superimposed on the substantially flat road surface when the transmissive display device 2 displays the display image for adjustment.

Therefore, the distance range detecting unit 16 detects the distance range of 10 to 25 m ahead of the eye position P as an adjustable distance range. In this case, adjustment by the adjustment unit 6 is performed on the basis of the third condition among the adjustment conditions in a state where the reference light is emitted to a position 10 m ahead of the eye position P and in a state where the reference light is emitted to a position 20 m ahead of the eye position P.

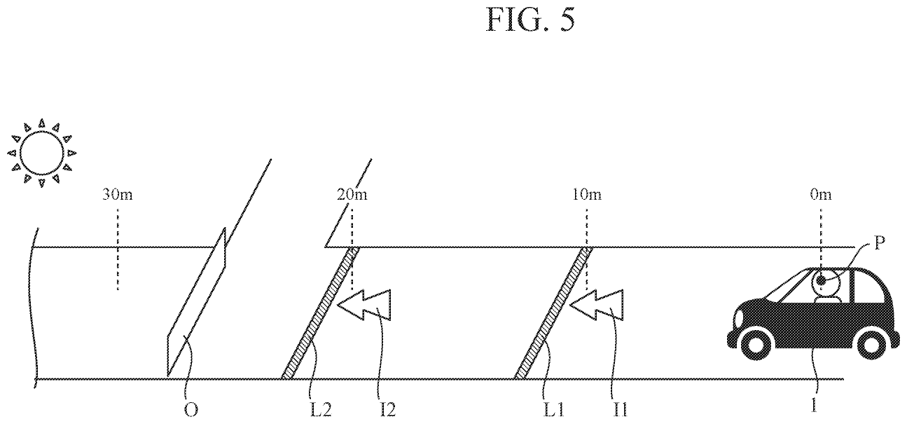

FIG. 5 illustrates an example of reference light L1 emitted to a position of 10 m ahead of the eye position P and reference light L2 emitted to a position 20 m ahead of the eye position P. As illustrated in FIG. 5, the reference light L1 and L2 corresponding to the respective distances are linear.

Also illustrated in FIG. 5 are a virtual image I1 by a display image for adjustment corresponding to the distance of 10 m ahead of the eye position P and a virtual image I2 by a display image for adjustment corresponding to the distance of 20 m ahead of the eye position P as one example. As illustrated in FIG. 5, the virtual images I1 and I2 corresponding to the respective distances are arrow-shaped virtual images arranged on the road surface ahead of the vehicle 1. That is, the display image for adjustment (not illustrated) corresponding to the distance of 10 m includes an arrow-shaped image for the left eye and an arrow-shaped image for the right eye which enable the virtual image I1 by stereoscopic vision. The display image for adjustment (not illustrated) corresponding to the distance of 20 m includes an arrow-shaped image for the left eye and an arrow-shaped image for the right eye which enable the virtual image I2 by stereoscopic vision.

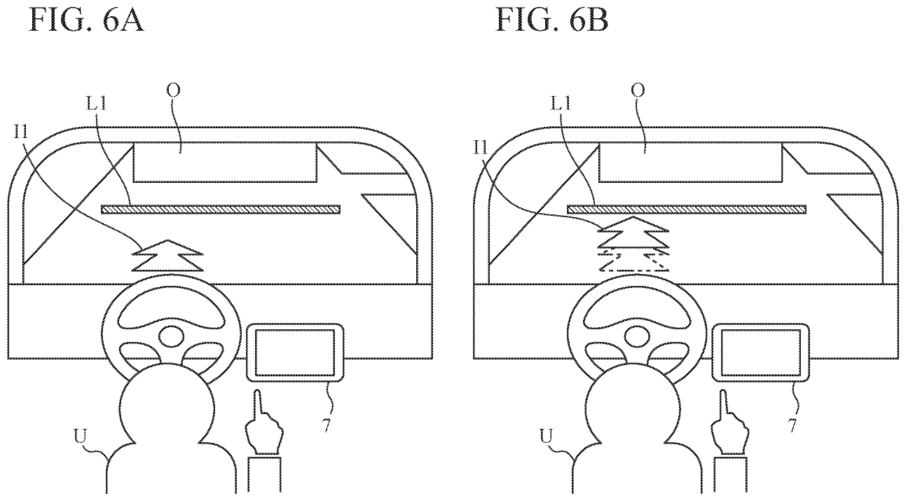

FIG. 6A is a diagram illustrating a state in which the obstacle O, the reference light L1, and the virtual image I1 before adjustment are viewed from the inside of the vehicle 1. In the figure, U denotes a passenger of the vehicle 1, that is, a user of the display system 200. Hereinafter, the near side viewed from the user U is simply referred to as “near side”, and the far side viewed from the user U is simply referred to as “far side”.

In the state illustrated in FIG. 6A, a tip of the virtual image I1 is arranged on the near side with respect to the reference light L1. That is, the position of the virtual image I1 in the outside view includes an error with respect to the position indicated by the reference light L1. For this, the user U inputs operation to the operation input device 7, and thereby the adjustment unit 6 performs adjustment of the display image corresponding to the virtual image I1. The adjustment is to shift the position of the virtual image I1 in the outside view to the far side.

That is, adjustment to shift the position of the display image on the projection plane upward, adjustment to reduce the size of the display image on the projection plane, adjustment to increase the binocular parallax of the display image (that is, adjustment to increase the parallax value between the image for the left eye and the image for the right eye), adjustment to change the brightness of the display image (that is, adjustment to increase or decrease the brightness value of the display image), or the like is performed.

The virtual image I1 after the adjustment is illustrated to FIG. 6B. As illustrated in FIG. 6B, the tip of the virtual image I1 is arranged close to the reference light L1, compared with the state before the adjustment (that is, the state illustrated in FIG. 6A). That is, the error in the position of the virtual image I1 in the outside view is reduced. When operation indicating the end of the adjustment is input to the operation input device 7, the adjustment unit 6 causes the adjustment result storing unit 18 to store the value of the detected illuminance, the value of each of the distances at which the adjustment has been performed (10 m and 20 m), and an adjustment result corresponding to each of the distances.

The adjustment relating to the reference light L2 and the virtual image I2 is similar to the adjustment relating to the reference light L1 and the virtual image I1, and thus illustration and description thereof are omitted. In step ST4, the adjustment unit 6 first performs the adjustment relating to the reference light L1 and the virtual image I1, and then performs the adjustment relating to the reference light L2 and the virtual image I2. That is, when performing the adjustment corresponding to each of the distances, the adjustment unit 6 sequentially performs adjustment from adjustment corresponding to a distance closer to the vehicle 1. Note that the order of performing adjustment in a case where the adjustment unit 6 performs adjustment corresponding to each of a plurality of distances is not limited to the above order, and may be any order.

Note that, in the example illustrated in FIGS. 4 to 6, the adjustment unit 6 does not perform adjustment corresponding to each of distances (30 m, 40 m, and 50 m) outside the adjustable distance range. In this case, after the adjustment in step ST4 is completed, the position, the size, the binocular parallax, the brightness of the display image, etc. when the transmissive display device 2 displays a display image corresponding to each of the distances of 30 m, 40 m, and 50 m are default values preset in the display system 200.

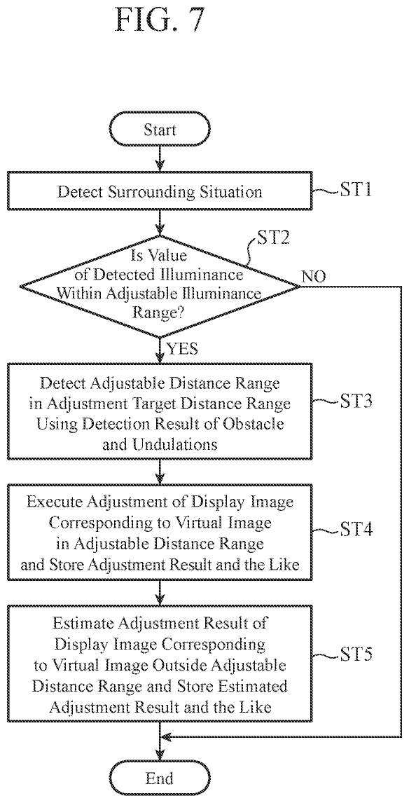

Meanwhile, the adjustment unit 6 may estimate adjustment results of the display images corresponding to the virtual images outside the adjustment target distance range using the adjustment results in step ST4. A flowchart in this case is illustrated in FIG. 7.

In step ST5, the adjustment unit 6 acquires, from the adjustment result storing unit 18, the values of the distances and the adjustment results stored in the adjustment result storing unit 18 in step ST4. The adjustment unit 6 estimates adjustment results of the display images corresponding to the virtual images outside the adjustable distance range by using the acquired values of the distances and the adjustment results. The adjustment unit 6 causes the adjustment result storing unit 18 to store the values of the respective distances at which the adjustment results have been estimated and the estimated adjustment results.

An adjustment result is estimated by, for example, a proportional expression. That is, it is assumed that the adjustment of positions in step ST4 has set position coordinates [x1, y1] of the display image corresponding to the distance of 10 m and position coordinates [x2, y2] of the display image corresponding to the distance of 20 m. In step ST5, the adjustment unit 6 estimates position coordinates [x3, y3] of the display image corresponding to the distance of 30 m by the following equations (1).

x1:x2=x2:x3

y1:y2=y2:y3 (1)

It is also assumed that a size s1 of the display image corresponding to the distance of 10 m and a size s2 of the display image corresponding to the distance of 20 m are set by the adjustment of sizes in step ST4. In step ST5, the adjustment unit 6 estimates a size s3 of the display image corresponding to the distance of 30 m by the following equation (2).

s1:s2=s2:s3 (2)

Moreover, it is assumed that a parallax value d1 of the display image corresponding to the distance of 10 m and a parallax value d2 of the display image corresponding to the distance of 20 m are set by the adjustment of the binocular parallax in step ST4. In step ST5, the adjustment unit 6 estimates a parallax value d3 of the display image corresponding to the distance of 30 m by the following equation (3).

d1:d2=d2:d3 (3)

Furthermore, it is assumed that a brightness value 11 of the display image corresponding to the distance of 10 m and a brightness value 12 of the display image corresponding to the distance of 20 m are set by the adjustment of the brightness in step ST4. In step ST5, the adjustment unit 6 estimates a brightness value 13 of the display image corresponding to the distance of 30 m by the following equation (4).

11:12=12:13 (4)

Likewise, the adjustment unit 6 estimates position coordinates [x4, y4], a size s4, a parallax value d4, and a brightness value 14 of the display image corresponding to the distance of 40 m. The adjustment unit 6 further estimates position coordinates [x5, y5], a size s5, a parallax value d5, and a brightness value 15 of the display image corresponding to the distance of 50 m.

Meanwhile, when the adjustment unit 6 receives the value of the detected illuminance from the illuminance determining unit 15 and the adjustable distance range from the distance range detecting unit 16, the adjustment unit 6 may acquire, from the adjustment result storing unit 18, an illuminance value and a distance value having been stored in the adjustment result storing unit 18 in previous adjustment. The adjustment unit 6 may avoid performing adjustment for a plurality of times in the same illuminance environment for the same distance by canceling adjustment corresponding to at least a partial distance depending on the acquired values. This allows the amount of calculation in the second and subsequent adjustment to be reduced, thereby reducing the processing load of the adjustment device 100.

Meanwhile, for example when an obstacle is present at a position 5 m ahead of the vehicle 1, this means that there is no distance as a target of adjustment within the adjustable distance range. In this case, the adjustment unit 6 may cancel execution of adjustment like in a case where it is determined that the value of the detected illuminance is outside the adjustable illuminance range.

Moreover, the adjustment conditions are not limited to the first condition, the second condition, or the third condition. The contents of processing by the adjustment condition determining unit 17 are not limited to the determination of whether the value of the detected illuminance is within the adjustable illuminance range or the detection of the adjustable distance range. The adjustment conditions may include any condition as long as the condition pertains to adjustment performed by the adjustment unit 6. The adjustment condition determining unit 17 is only required to perform some type of determination related to the propriety or the range of adjustment by the adjustment unit 6 on the basis of the adjustment condition. The adjustment unit 6 is only required to perform or cancel adjustment depending on a determination result by the adjustment condition determining unit 17.

The adjustment condition determining unit 17 may not include the illuminance determining unit 15 illustrated in FIG. 1. In this case, the surrounding situation detecting device 13 may not include the illuminance meter 12 illustrated in FIG. 1. The adjustment conditions may not include the first condition.

Moreover, a display image displayed on the projection plane is not limited to an arrow. The display image may be any image as long as the position of a virtual image in the outside view can be adjusted.

In addition, the surrounding situation detecting unit 8 may detect only one of an obstacle and undulations of a road surface by using at least one of the camera 9, the radar 10, and the sonar 11.

Furthermore, a target of adjustment by the adjustment unit 6 is not limited to the position, the size, the binocular parallax, or the brightness of a display image on the projection plane. The adjustment unit 6 may adjust any parameter of a display image as long as the position of a virtual image in the outside view can be adjusted.

The transmissive display device 2 is not limited to an HUD. The transmissive display device 2 may include, for example, a transparent liquid crystal display or a transparent organic electro luminescence (EL) display provided integrally with the projection plane.

Moreover, the transmissive display device 2 is not limited to a display device for stereoscopic vision. The transmissive display device 2 may be a display device based on so-called “2D display”. However, a display device for stereoscopic vision is more likely to give discomfort to a user due to an error in the position of a virtual image than a display device based on 2D display does. For this reason, the effect of mitigating the discomfort by adjustment of a display image is also large, and thus the adjustment device 100 is suitable for use.

Furthermore, the projection plane is not limited to the windshield of the vehicle 1 or the combiner arranged to face the windshield.

For example, the transmissive display device 2 may display a display image on a side glass of the vehicle 1 or a combiner arranged to face the side glass. In this case, the lighting device 4 may emit reference light to a road surface on a side of the vehicle 1. The surrounding situation detecting unit 8 may detect an obstacle present on a side of the vehicle 1 and also detect undulations on a road surface on a side of the vehicle 1 by using at least one of the camera 9, the radar 10, and the sonar 11.

Alternatively, for example, the transmissive display device 2 may display a display image on a rear glass of the vehicle 1 or a combiner arranged to face the rear glass. In this case, the lighting device 4 may emit reference light to a road surface behind the vehicle 1. The surrounding situation detecting unit 8 may detect an obstacle present behind the vehicle 1 and also detect undulations on a road surface behind the vehicle 1 by using at least one of the camera 9, the radar 10, and the sonar 11.

The lighting device 4 is not limited to the light source provided integrally with the headlamp of the vehicle 1. The lighting device 4 may be, for example, integrally configured with a tail lamp of the vehicle 1 or may be a dedicated light source provided on the ceiling of the vehicle 1.

Moreover, the control device 20 may be included in a navigation device (not illustrated) mounted to the vehicle 1. That is, the processor 21 and the memory 22 illustrated in FIG. 2A or the processing circuit 24 illustrated in FIG. 2B may be built in the navigation device.

Alternatively, the control device 20 may be included in a portable information terminal (not illustrated) brought into vehicle 1. That is, the processor 21 and the memory 22 illustrated in FIG. 2A or the processing circuit 24 illustrated in FIG. 2B may be built in the portable information terminal. The portable information terminal may be, for example, a smartphone, a tablet computer, or a portable navigation device (PND).

Alternatively, the control device 20 may be provided outside the vehicle 1 and included in a server device (not illustrated) that can freely communicate with the vehicle 1. That is, the processor 21 and the memory 22 illustrated in FIG. 2A or the processing circuit 24 illustrated in FIG. 2B may be built in the server device.

Alternatively, the functions of the respective functional units of the control device 20 may be implemented by cooperation of at least two of the navigation device, the portable information terminal, and the server device.

The meaning of the term “flat” described in claims of the present application is not limited to a completely flat state but also includes a substantially flat state.

As described above, in the adjustment device 100 according to the first embodiment, a position of a virtual image corresponding to a display image in a view outside the vehicle is adjusted by adjustment of the display image by the in-vehicle transmissive display device 2, the adjustment device 100 including the adjustment unit 6 for performing adjustment of the display image depending on operation input to the operation input device 7 in a state where reference light, serving as a reference for the position of the virtual image, is emitted to a road surface; and the adjustment condition determining unit 17 for detecting an adjustable distance range, in which the adjustment can be performed, in an adjustment target distance range set to be subjected to the adjustment, in which the adjustment unit 6 performs the adjustment of the display image corresponding to the virtual image in the adjustable distance range in a state where the reference light is emitted to a road surface in the adjustable distance range. As a result, adjustment can be performed within the distance range in which the adjustment can be normally performed.

The adjustment is to bring the position of the virtual image closer to a position indicated by the reference light by adjustment of the position, the size, the binocular parallax, or the brightness of the display image. By such adjustment, it is possible to mitigate the discomfort experienced by the user.

The adjustment device 100 further includes the surrounding situation detecting unit 8 for detecting an obstacle or undulations of the road surface by using the camera 9, the radar 10, or the sonar 11 provided in the vehicle 1 having the transmissive display device 2. The adjustment condition determining unit 17 detects, as the adjustable distance range, a distance range in which the reference light is emitted on a flat road surface, by using a detection result by the surrounding situation detecting unit 8. As a result, the adjustable distance range can be detected.

The adjustment device 100 further includes the surrounding situation detecting unit 8 for detecting the illuminance using the illuminance meter 12 provided in the vehicle 1 having the transmissive display device 2. The adjustment condition determining unit 17 determines whether a value of the detected illuminance by the surrounding situation detecting unit 8 is within an adjustable illuminance range in which the adjustment can be performed, and the adjustment unit 6 performs the adjustment in a case where the value of the detected illuminance is within the adjustable illuminance range. As a result, adjustment can be performed in an illuminance environment in which the adjustment can be normally performed.

The adjustment unit 6 further estimates an adjustment result of a display image corresponding to a virtual image outside the adjustable distance range by using the adjustment result of the display image corresponding to the virtual image within the adjustable distance range. With the processing of step ST5 illustrated in FIG. 7, it is possible to mitigate the discomfort experienced by a user also for a virtual image corresponding to each distance outside the adjustable distance range.

The transmissive display device 2 includes a head-up display for stereoscopic vision. A display device for stereoscopic vision is more likely to give discomfort to a user due to an error in the position of a virtual image than a display device based on 2D display does. For this reason, the effect of mitigating the discomfort by the adjustment device 100 is also large, and thus the adjustment device 100 is suitable for use.

In addition, the display system 200 according to the first embodiment includes the in-vehicle transmissive display device 2; and the adjustment device 100 in which a position of a virtual image corresponding to a display image in a view outside the vehicle is adjusted by adjustment of the display image by the transmissive display device 2, the adjustment device 100 including the adjustment unit 6 for performing adjustment of the display image depending on operation input to the operation input device 7 in a state where reference light, serving as a reference for the position of the virtual image, is emitted to a road surface; and the adjustment condition determining unit 17 for detecting an adjustable distance range, in which the adjustment can be performed, in an adjustment target distance range set to be subjected to the adjustment. The adjustment unit 6 performs the adjustment of the display image corresponding to the virtual image in the adjustable distance range in a state where the reference light is emitted to a road surface in the adjustable distance range. As a result, the effects similar to those of the adjustment device 100 can be obtained.

An adjustment method according to the first embodiment in which a position of a virtual image corresponding to a display image in a view outside a vehicle is adjusted by adjustment of the display image by the in-vehicle transmissive display device 2, the adjustment method including a step of performing adjustment of the display image, by the adjustment unit 6, depending on operation input to the operation input device 7 in a state where reference light, serving as a reference for the position of the virtual image, is emitted to a road surface (step ST4); and a step of detecting an adjustable distance range (step ST3), in which the adjustment can be performed, by the adjustment condition determining unit 17, in an adjustment target distance range set to be subjected to the adjustment. The adjustment unit 6 performs the adjustment of the display image corresponding to the virtual image in the adjustable distance range in the step of performing the adjustment (step ST4) in a state where the reference light is emitted to a road surface in the adjustable distance range. As a result, the effects similar to those of the adjustment device 100 can be obtained.

### Second Embodiment

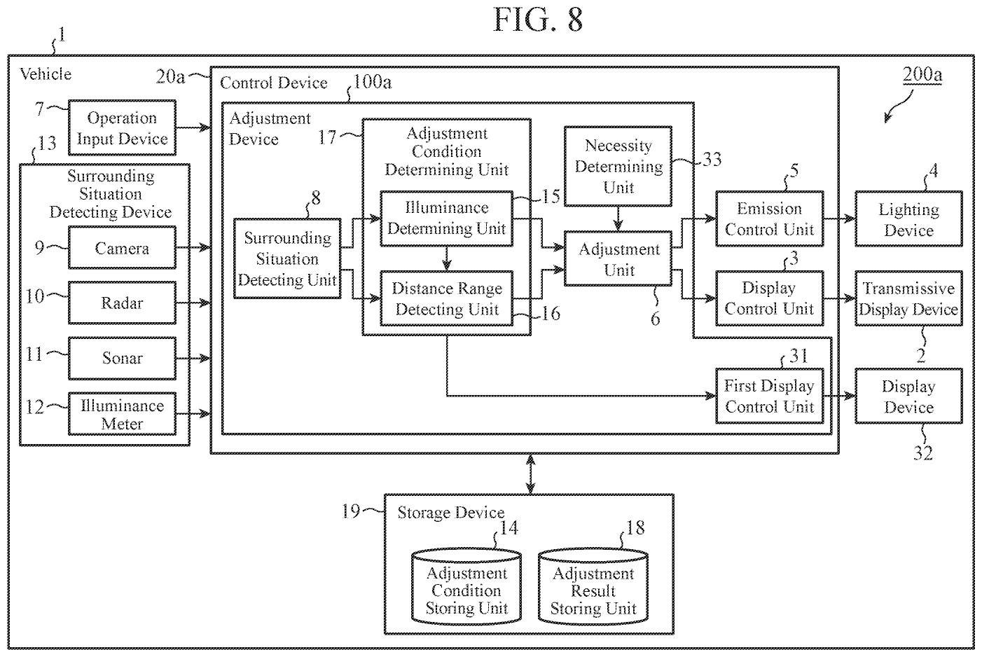

FIG. 8 is an explanatory diagram which is a combination of a functional block diagram illustrating a main part of an adjustment device according to a second embodiment of the present invention and a system configuration diagram illustrating a main part of a display system including the adjustment device. An adjustment device 100a of the second embodiment and a display system 200a including the adjustment device 100a will be described with reference to FIG. 8.

Note that in FIG. 8 the same symbol is given to a block similar to that in the explanatory diagram of the first embodiment illustrated in FIG. 1, and descriptions thereof will be omitted. In addition, since hardware configurations of a control device 20a and a storage device 19 according to the second embodiment are similar to those described with reference to FIG. 2 in the first embodiment, illustration and description thereof are omitted.

An illuminance determining unit 15 outputs the value of a detected illuminance to a first display control unit 31 when determining that the value of the illuminance detected by a surrounding situation detecting unit 8 is within an adjustable illuminance range. When the adjustable distance range is detected, a distance range detecting unit 16 outputs the detected adjustable distance range to the first display control unit 31.

The first display control unit 31 generates an image indicating the value of the detected illuminance input from the illuminance determining unit 15 and the adjustable distance range input from the distance range detecting unit 16 (hereinafter referred to as “first image”). The first display control unit 31 executes control to cause a display device 32 to display the generated first image. The display device 32 includes, for example, a liquid crystal display or an organic EL display included in a navigation device (not illustrated) mounted to a vehicle 1.

A necessity determining unit 33 determines the necessity of adjustment by an adjustment unit 6 depending on operation input to an operation input device 7 in a state where the first image is displayed on the display device 32. That is, the first image includes text or a button for prompting selection whether adjustment is necessary. The necessity determining unit 33 outputs the determination result to the adjustment unit 6.

The adjustment unit 6 performs adjustment when the necessity determining unit 33 determines that adjustment is necessary. On the other hand, when it is determined by the necessity determining unit 33 that adjustment is unnecessary, the adjustment unit 6 cancels execution of adjustment.

The surrounding situation detecting unit 8, the adjustment condition determining unit 17, the first display control unit 31, the necessity determining unit 33, and the adjustment unit 6 form the adjustment device 100a. The adjustment device 100a, an emission control unit 5, and a display control unit 3 form the control device 20a. The operation input device 7, a surrounding situation detecting device 13, the control device 20a, the storage device 19, a lighting device 4, a transmissive display device 2, and the display device 32 form the display system 200a.

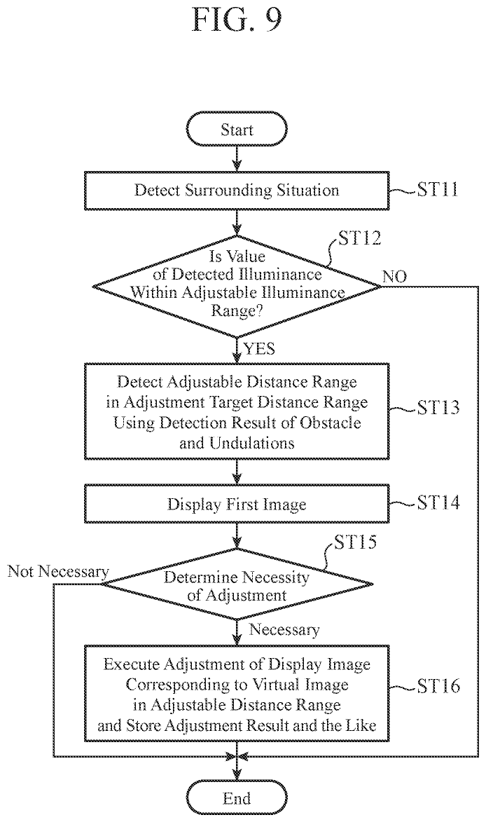

Next, the operation of the adjustment device 100a will be described with reference to a flowchart of FIG. 9. Note that adjustment conditions are prestored in the adjustment condition storing unit 14. When operation indicating the start of adjustment is input to the operation input device 7, the adjustment device 100a starts processing of step ST11.

First in step ST11, the surrounding situation detecting unit 8 detects a surrounding situation. Since the processing contents of step ST11 are similar to those of step ST1 illustrated in FIG. 3, description thereof is omitted.

Next, in step ST12, the illuminance determining unit 15 determines whether the value of the detected illuminance in step ST11 is within the adjustable illuminance range. The illuminance determining unit 15 outputs the determination result to the adjustment unit 6 and the distance range detecting unit 16. If it is determined that the value of the detected illuminance is within the adjustable illuminance range (“YES” in step ST12), the illuminance determining unit 15 outputs the value of the detected illuminance to the adjustment unit 6 and the first display control unit 31.

If it is determined that the value of the detected illuminance is within the adjustable illuminance range (“YES” in step ST12), the distance range detecting unit 16 detects an adjustable distance range in an adjustment target distance range in step ST13. Since the processing contents of step ST13 are similar to those of step ST3 illustrated in FIG. 3, description thereof is omitted. The distance range detecting unit 16 outputs the detected adjustable distance range to the adjustment unit 6 and the first display control unit 31.

Next, in step ST14, the first display control unit 31 causes the display device 32 to display the first image. The first image indicates the value of the detected illuminance input from the illuminance determining unit 15 in step ST12 and the adjustable distance range input from the distance range detecting unit 16 in step ST13. The first image also includes text or a button for prompting selection whether adjustment is necessary.

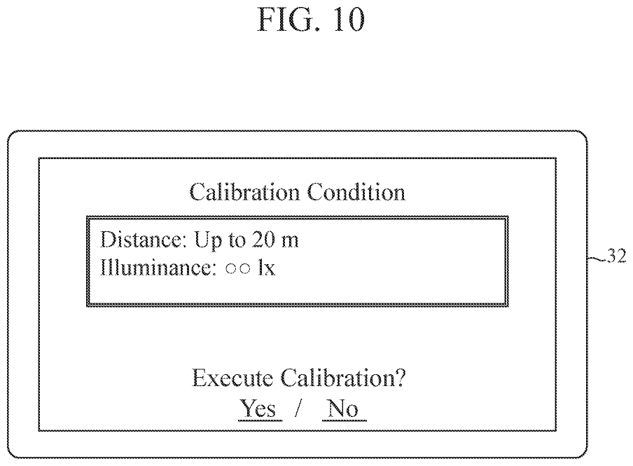

In FIG. 10, an exemplary first image displayed on the display device 32 is illustrated. The first display control unit 31 continues the control of causing the display device 32 to display the first image until the necessity determining unit 33 determines whether adjustment is necessary.

Next in step ST15, the necessity determining unit 33 determines whether adjustment by the adjustment unit 6 is necessary depending on operation input to the operation input device 7. That is, if “Yes” is selected by the operation input to operation input device 7 for the first image illustrated in FIG. 10, the necessity determining unit 33 determines that adjustment is necessary (“Necessary” in step ST15). On the other hand, if “No” is selected by the operation input to the operation input device 7, the necessity determining unit 33 determines that adjustment is unnecessary (“Not Necessary” in step ST15). The necessity determining unit 33 outputs the determination result to the adjustment unit 6.

If it is determined that adjustment is not necessary (“Not Necessary” in step ST15), the adjustment unit 6 cancels execution of adjustment. Thus, the processing of the adjustment device 100a completes.

On the other hand, if it is determined that adjustment is necessary (“Necessary” in step ST15), the adjustment unit 6 performs adjustment in step ST16. Since the processing contents of step ST16 are similar to those of step ST4 illustrated in FIG. 3, description thereof is omitted.

In this manner, the first display control unit 31 causes the display device 32 to display the first image. This allows the user to be informed of the current illuminance environment, the adjustable distance range, and the like.

Moreover, the first display control unit 31 causes the display device 32 to display the first image before the adjustment unit 6 performs adjustment. The adjustment unit 6 performs adjustment when the necessity determining unit 33 determines that adjustment is necessary. This can prevent adjustment not pursuant to the user's intention.

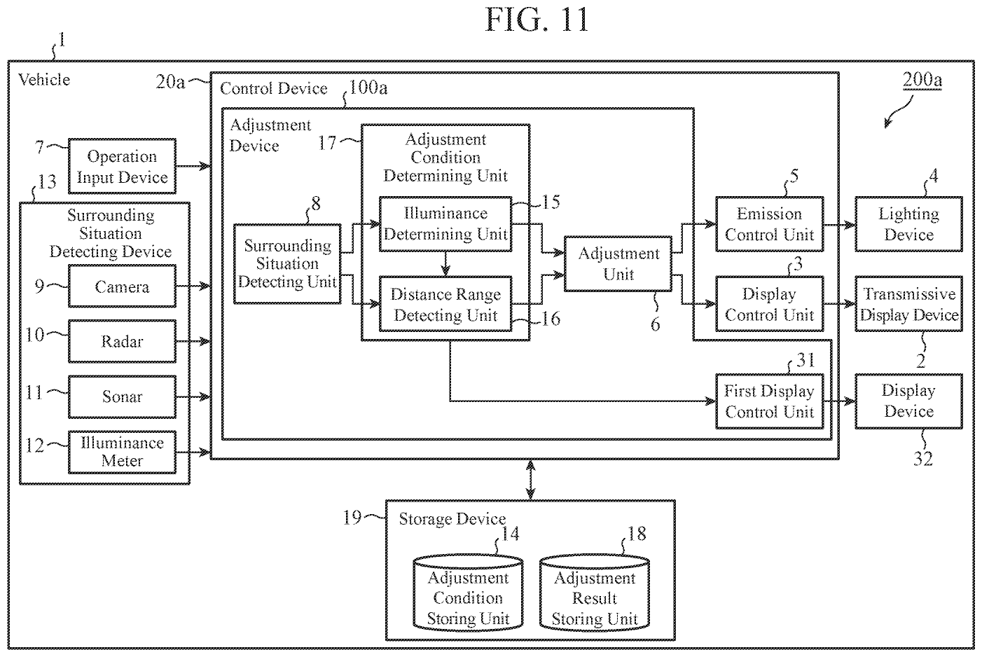

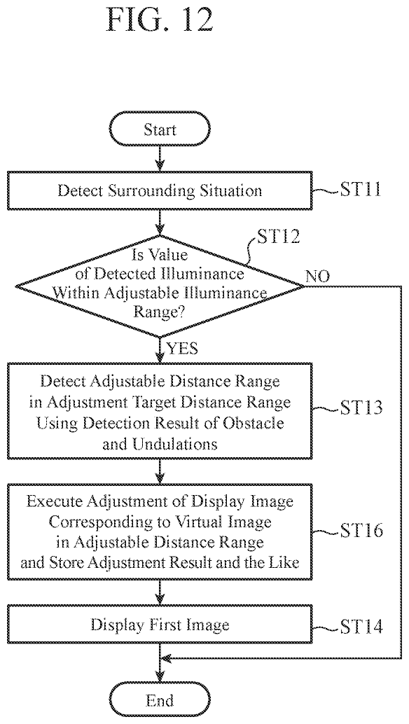

Note that the first display control unit 31 may cause the display device 32 to display the first image after the adjustment unit 6 performs adjustment. In this case, the adjustment device 100a may not include the necessity determining unit 33 illustrated in FIG. 8. A functional block diagram and a system configuration diagram in this case are illustrated in FIG. 11, and a flowchart is illustrated in FIG. 12.

As illustrated in FIG. 12, first, the surrounding situation detecting unit 8 executes the processing of step ST11, and then the illuminance determining unit 15 executes the processing of step ST12. If the determination result of step ST12 is “YES”, the distance range detecting unit 16 executes the processing of step ST13, and then the adjustment unit 6 executes the processing of step ST16.

Next, in step ST14, the first display control unit 31 causes the display device 32 to display the first image. The first image indicates the value of the detected illuminance input from the illuminance determining unit 15 in step ST12 and the adjustable distance range input from the distance range detecting unit 16 in step ST13. Note that the first image does not include text or a button for prompting selection whether adjustment is necessary.

The first image is only required to indicate the adjustable distance range. That is, the first image may not indicate the value of the detected illuminance. The first image may further indicate various types of information related to the determination result by the adjustment condition determining unit 17 in addition to the adjustable distance range.

The display device 32 may be any device capable of displaying the first image and is not limited to a liquid crystal display or an organic EL display included in a navigation device (not illustrated).

In addition, the adjustment device 100a and the display system 200a can adopt various modifications similar to those described in the first embodiment.

As described above, the adjustment device 100a according to the second embodiment includes the first display control unit 31 for causing the display device 32 to display the first image indicating the adjustable distance range. This allows the user to be informed of the adjustable distance range and the like.

In addition, the first display control unit 31 causes the display device 32 to display the first image before the adjustment unit 6 performs adjustment, and the adjustment device 100a further includes the necessity determining unit 33 for determining the necessity of adjustment depending on operation input to the operation input device 7 in a state where the first image is displayed on the display device 32. With the processing of step ST14 illustrated in FIG. 9, the user can be notified of the adjustable distance range and the like before adjustment is performed. The processing of step ST15 can prevent adjustment not pursuant to the user's intention.

Alternatively, the first display control unit 31 causes the display device 32 to display the first image after the adjustment unit 6 performs adjustment. With the processing of step ST14 illustrated in FIG. 12, the user can be notified of the adjustable distance range and the like in the latest adjustment, that is, a distance range in which adjustment has been performed in the latest adjustment. As a result, the user can grasp a distance range in which adjustment has not been performed in the latest adjustment.

### Third Embodiment

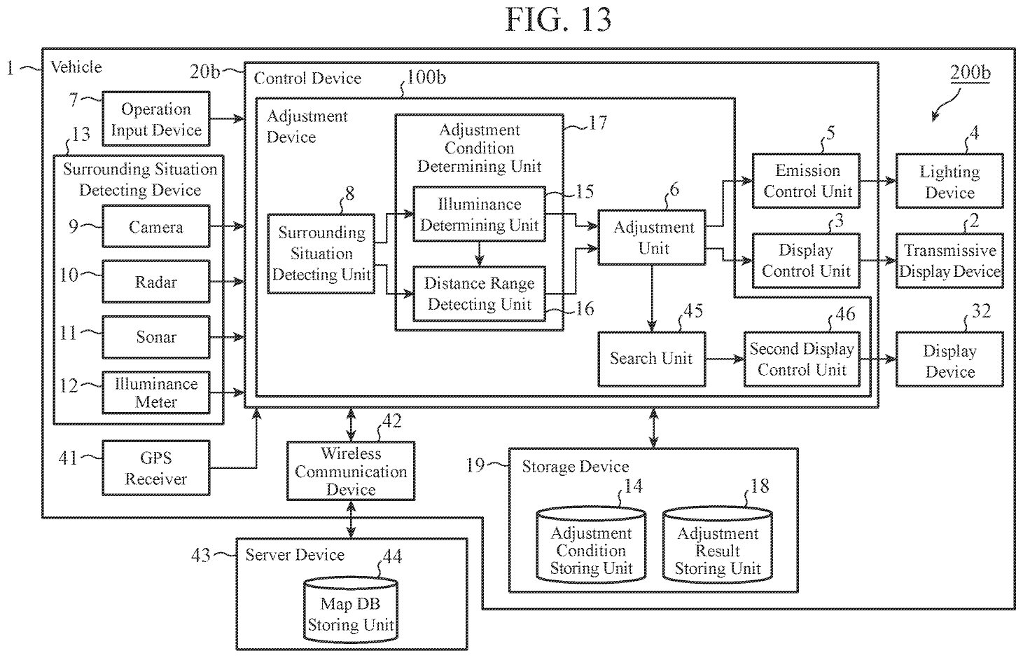

FIG. 13 is an explanatory diagram which is a combination of a functional block diagram illustrating a main part of an adjustment device according to a third embodiment of the present invention and a system configuration diagram illustrating a main part of a display system including the adjustment device. An adjustment device 100b according to the third embodiment and a display system 200b including the adjustment device 100b will be described with reference to FIG. 13.

Note that in FIG. 13 the same symbol is given to a block similar to that in the explanatory diagram of the first embodiment illustrated in FIG. 1, and descriptions thereof will be omitted. In addition, since hardware configurations of a control device 20b and a storage device 19 according to the third embodiment are similar to those described with reference to FIG. 2 in the first embodiment, illustration and description thereof are omitted.

A vehicle 1 has a global positioning system (GPS) receiver 41. The GPS receiver 41 receives GPS signals from GPS satellites (not illustrated).

The control device 20b can freely communicate with a server device 43 provided outside the vehicle 1 using a wireless communication device 42. The wireless communication device 42 includes, for example, a dedicated receiver and transmitter mounted to the vehicle 1. Alternatively, for example, the wireless communication device 42 includes a portable information terminal such as a smartphone brought into the vehicle 1.

The server device 43 includes a map database storing unit (hereinafter referred to as “map DB storing unit”) 44. The map DB storing unit 44 stores a map database (hereinafter referred to as “map DB”).

Here, the map DB includes normal map information for car navigation. In addition to this, the map DB includes information indicating a place where the value of the detected illuminance is within the adjustable illuminance range and adjustment can be normally performed over at least a partial distance range in an adjustment target distance range (hereinafter referred to as “place information”). The place information also indicates a distance range in which adjustment can be normally performed at each place. Note that the distance range in which adjustment can be normally performed refers to, for example, a distance range in which reference light is emitted to a substantially flat road surface when a lighting device 4 emits the reference light, and a virtual image is superimposed on the substantially flat road surface when the transmissive display device 2 displays a display image for adjustment.

That is, the map DB is a database in which the map information and the place information are associated. The place information is updated in substantially real time using, for example, information received from illuminance meters provided at various places, probe information received from a plurality of vehicles including the vehicle 1, and the like.

A search unit 45 calculates the current position of the vehicle 1 (hereinafter referred to as “host vehicle position”) using the GPS signals received by the GPS receiver 41. In addition, the search unit 45 acquires information included in the map DB stored in the map DB storing unit 44 by communicating with the server device 43 using the wireless communication device 42. The search unit 45 searches for a place suitable for adjustment by an adjustment unit 6 using the calculated host vehicle position and the acquired information.

Specifically, for example, the search unit 45 searches for a place where adjustment can be normally performed over the entire adjustment target distance range among a plurality of places indicated by the place information. In a case where there is a plurality of places satisfying such a condition, the search unit 45 further searches for a place closest to the host vehicle position among these places. Hereinafter, such a search method is referred to as “first search method”.

Alternatively, for example, the search unit 45 searches for a distance range including a distance for which no adjustment result is stored in an adjustment result storing unit 18 among the plurality of places indicated by the place information, that is, a place where adjustment can be normally performed over a distance range in which the adjustment unit 6 has not performed adjustment before. In a case where there is a plurality of places satisfying such a condition, the search unit 45 further searches for a place closest to the host vehicle position among these places. Hereinafter, such a search method is referred to as “second search method”.

The adjustment unit 6 instructs the search unit 45 to search for a place suitable for adjustment when adjustment of the display image is completed or when execution of adjustment is cancelled. The search unit 45 searches for a place suitable for adjustment in response to an instruction from the adjustment unit 6. The search unit 45 outputs the search result to a second display control unit 46.

The second display control unit 46 generates an image indicating the search result by the search unit 45 (hereinafter, referred to as “second image”). The second display control unit 46 causes a display device 32 to display the generated second image. The display device 32 includes, for example, a liquid crystal display or an organic EL display included in a navigation device (not illustrated) mounted to the vehicle 1.

A surrounding situation detecting unit 8, an adjustment condition determining unit 17, the adjustment unit 6, the search unit 45, and the second display control unit 46 form the adjustment device 100b. The adjustment device 100b, an emission control unit 5, and a display control unit 3 form the control device 20b. An operation input device 7, a surrounding situation detecting device 13, the GPS receiver 41, the control device 20b, the wireless communication device 42, the storage device 19, the lighting device 4, a transmissive display device 2, and the display device 32 form the display system 200b.

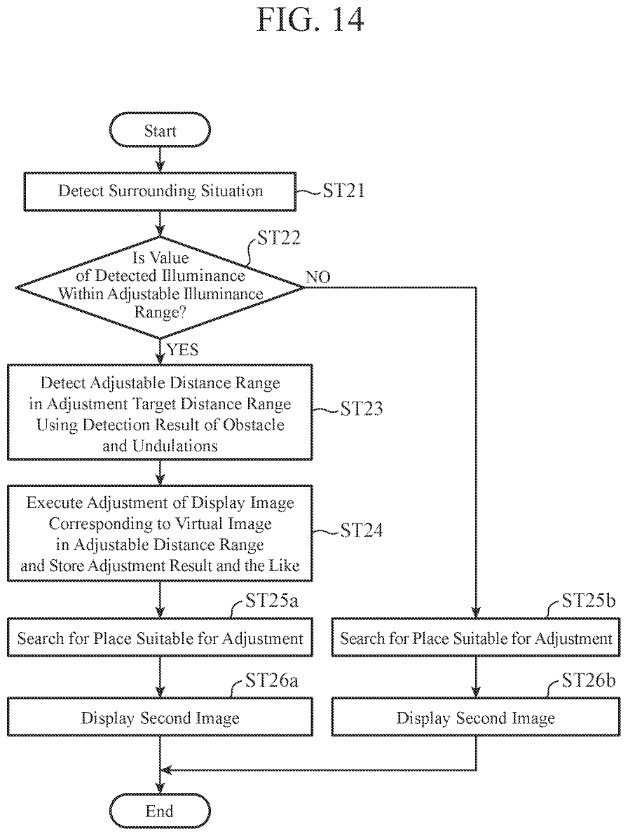

Next, with reference to a flowchart of FIG. 14, the operation of the adjustment device 100b will be described. Note that adjustment conditions are prestored in an adjustment condition storing unit 14, and the map DB is prestored in the map DB storing unit 44. When operation indicating the start of adjustment is input to the operation input device 7, the adjustment device 100b starts the processing of step ST21.

First, in step ST21, the surrounding situation detecting unit 8 detects the surrounding situation of the vehicle 1. Since the processing contents of step ST21 are similar to those of step ST1 illustrated in FIG. 3, description thereof is omitted.

Next, in step ST22, an illuminance determining unit 15 determines whether a value of a detected illuminance in step ST21 is within an adjustable illuminance range. The illuminance determining unit 15 outputs the determination result to the adjustment unit 6 and the distance range detecting unit 16. If it is determined that the value of the detected illuminance is within the adjustable illuminance range (“YES” in step ST22), the illuminance determining unit 15 outputs the value of the detected illuminance to the adjustment unit 6.

If it is determined that the value of the detected illuminance is within the adjustable illuminance range (“YES” in step ST22), the distance range detecting unit 16 detects an adjustable distance range in an adjustment target distance range in step ST23. Since the processing contents of step ST23 are similar to those of step ST3 illustrated in FIG. 3, description thereof is omitted. The distance range detecting unit 16 outputs the detected adjustable distance range to the adjustment unit 6.

Next, in step ST24, the adjustment unit 6 performs adjustment. Since the processing contents of step ST24 are similar to those of step ST4 illustrated in FIG. 3, description thereof is omitted. When operation indicating the end of the adjustment is input to the operation input device 7, the adjustment unit 6 instructs the search unit 45 to search for a place suitable for adjustment.

Next, in step ST25a, the search unit 45 searches for a place suitable for adjustment by the first search method or the second search method. The search unit 45 outputs the search result to the second display control unit 46. Next, in step ST26a, the second display control unit 46 causes the display device 32 to display the second image.

On the other hand, if it is determined that the value of the detected illuminance is outside the adjustable illuminance range (“NO” in step ST22), the adjustment unit 6 cancels execution of adjustment. The adjustment unit 6 instructs the search unit 45 to search for a place suitable for adjustment.

Next, in step ST25b, the search unit 45 searches for a place suitable for adjustment by the first search method or the second search method. The search unit 45 outputs the search result to the second display control unit 46. Next, in step ST26b, the second display control unit 46 causes the display device 32 to display the second image.

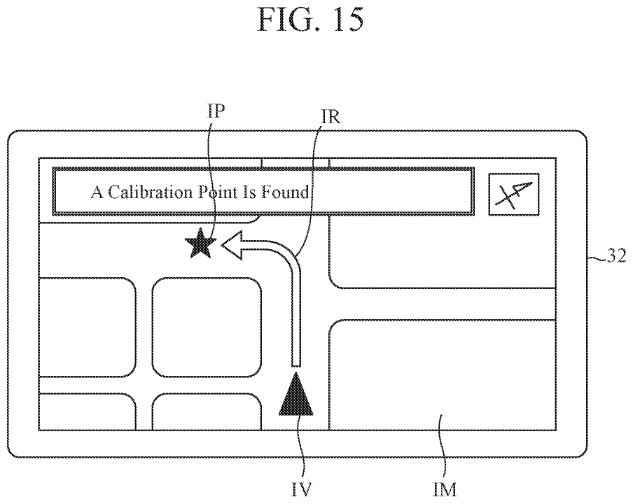

In FIG. 15, an exemplary second image displayed on the display device 32 is illustrated. As illustrated in FIG. 15, the second image includes a map image IM, an icon image IV indicating the host vehicle position, and an icon image IP indicating the place found by the search unit 45. The icon images IV and IP are superimposed on the map image IM. The second image may include also an arrow-shaped image IR indicating a travel route from the host vehicle position to the place found by the search unit 45. Note that the map image IM can be generated using the map information included in the map DB.

As described above, the adjustment device 100b according to the third embodiment searches for a place suitable for adjustment and causes the display device 32 to display the second image indicating the search result. This can inform the user of a place suitable for adjustment.

Note that the search unit 45 may search for a place suitable for adjustment by the following third search method. That is, the search unit 45 acquires the adjustable distance range detected by the distance range detecting unit 16. The search unit 45 searches for a place where adjustment can be normally performed over a distance range wider than the adjustable distance range detected by the distance range detecting unit 16 among the plurality of places indicated by the place information. In a case where there is a plurality of places satisfying such a condition, the search unit 45 further searches for a place closest to the host vehicle position among these places. This enables search for a place more suitable for adjustment than the host vehicle position is.

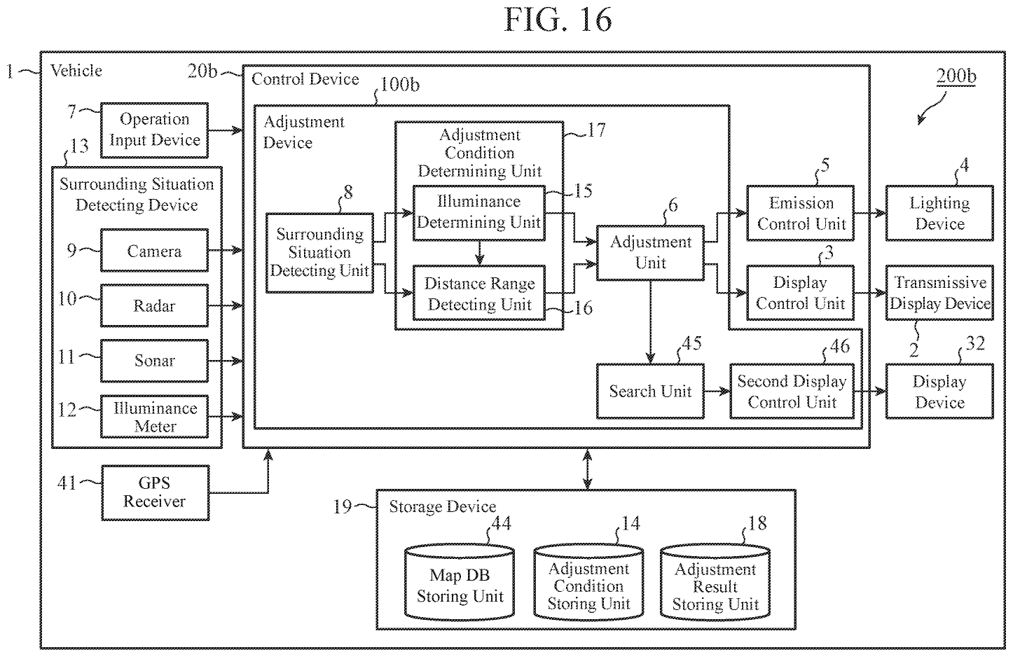

The map DB may be stored in the storage device 19 instead of the server device 43. A functional block diagram and a system configuration diagram in this case are illustrated in FIG. 16. As illustrated in FIG. 16, a map DB storing unit 44 is included in a storage device 19. In this case, place information may not include information related to the illuminance. That is, the place information may indicate a place where adjustment can be normally performed over at least a partial distance range of the adjustment target distance range and a distance range where adjustment can be normally performed at each place. Moreover, when the map information in the map DB is updated, the place information may also be updated.

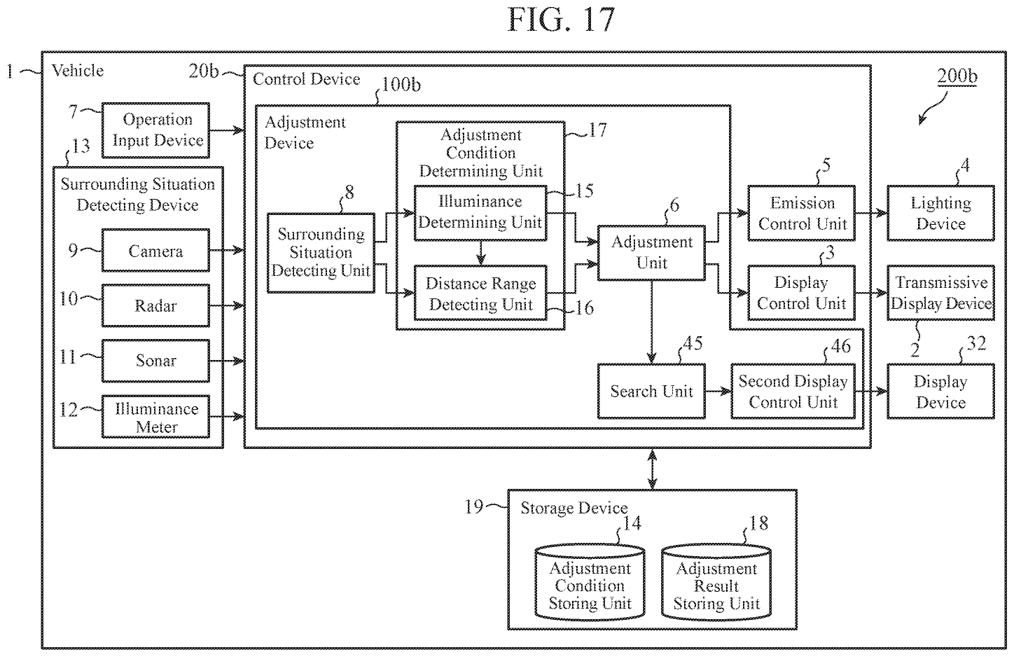

Alternatively, the search unit 45 may search for a place suitable for adjustment using an image photographed by a camera 9 instead of the host vehicle position or the place information. In this case, the camera 9 may photograph ahead of, a side of, and behind the vehicle 1. A functional block diagram and a system configuration diagram in this case are illustrated in FIG. 17.

In this case, for example, the search unit 45 searches for a place where adjustment can be normally performed over the entire adjustment target distance range among places captured in the photographed image by executing image recognition processing on the photographed image (first search method). Alternatively, for example, the search unit 45 searches for a place where adjustment can be normally executed over a distance range in which the adjustment unit 6 has not performed adjustment before among the places captured in the photographed image by executing image recognition processing on the photographed image (second search method). Further alternatively, for example, the search unit 45 searches for a place where the adjustment can be normally performed over a distance range wider than the adjustable distance range detected by the distance range detecting unit 16 among the places captured in the photographed image by executing image recognition processing on the photographed image (third search method).

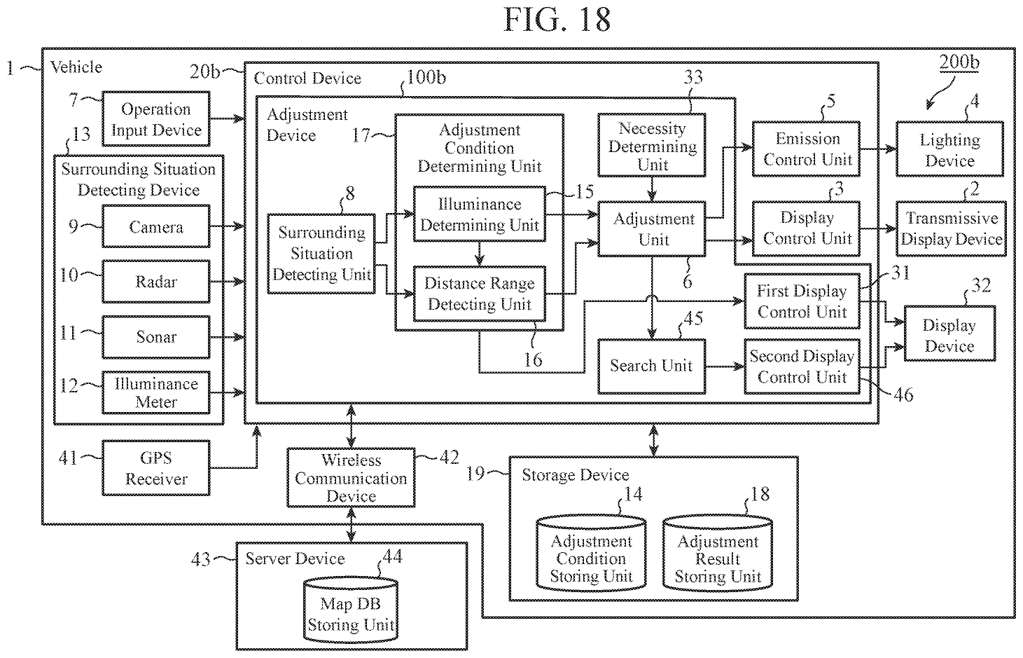

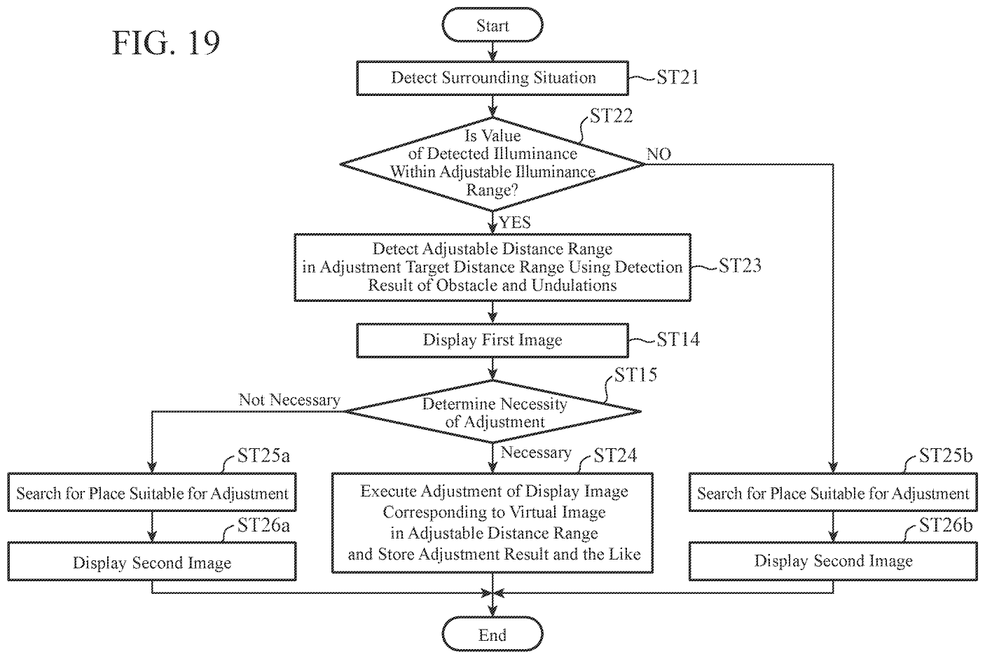

Furthermore, the adjustment device 100b may include a first display control unit 31 and a necessity determining unit 33 similar to those of the adjustment device 100a according to the second embodiment. A functional block diagram and a system configuration diagram in this case are illustrated in FIG. 18, and an exemplary flowchart is illustrated in FIG. 19.

As illustrated in FIG. 19, first, a surrounding situation detecting unit 8 executes the processing of step ST21, and then an illuminance determining unit 15 executes the processing of step ST22. If the determination result of step ST22 is “YES”, a distance range detecting unit 16 executes the processing of step ST23. Next, the first display control unit 31 executes the processing of step ST14, and then the necessity determining unit 33 executes the processing of step ST15.

If the determination result of step ST15 is “Necessary”, the adjustment unit 6 executes the processing of step ST24. On the other hand, if the determination result in step ST15 is “Not Necessary”, the adjustment unit 6 cancels execution of adjustment and instructs the search unit 45 to search for a place suitable for the adjustment. As a result, the search unit 45 executes the processing of step ST25a, and then the second display control unit 46 executes the processing of step ST26a.

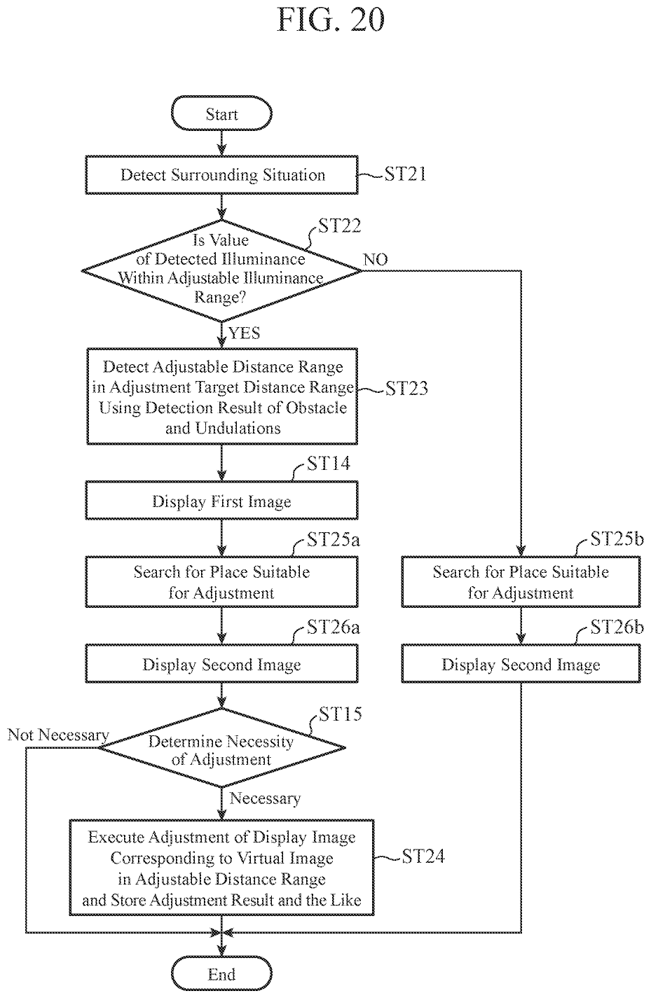

Alternatively, in the adjustment device 100b illustrated in FIG. 18, the processing of steps ST25a and ST26a may be executed before the adjustment unit 6 performs adjustment, more specifically, before the necessity determining unit 33 determines the necessity. A flowchart in this case is illustrated in FIG. 20.

In this case, the first display control unit 31 may continue the processing of displaying the first image until the necessity of the display is determined in step ST15 after the display of the first image has been started in step ST14. In addition, the second display control unit 46 may continue the processing of displaying the second image until the necessity of the display is determined in step ST15 after the display of the second image has been started in step ST26a. That is, the necessity determining unit 33 may determine the necessity of adjustment by the adjustment unit 6 depending on operation input to the operation input device 7 in a state where the first image and the second image are displayed on the display device 32. This allows the user to determine the necessity of adjustment at the host vehicle position while considering the adjustable distance range at the host vehicle position, the distance from the host vehicle position to a place suitable for adjustment, and the like.

In addition, the adjustment device 100b and the display system 200b can adopt various modifications similar to those described in the first and second embodiments.

As described above, the adjustment device 100b according to the third embodiment includes the search unit 45 for searching for a place suitable for adjustment; and the second display control unit 46 for causing the display device 32 to display the second image indicating the search result by the search unit 45. This can inform the user of a place suitable for adjustment.

The search unit 45 searches for a place suitable for adjustment using information included in the map database. This enables search for a place suitable for adjustment in the system configurations illustrated in FIGS. 13 and 16.

Alternatively, the search unit 45 searches for a place suitable for adjustment using an image photographed by the camera 9 provided in the vehicle 1 having the transmissive display device 2. This enables search for a place suitable for adjustment in the system configuration illustrated in FIG. 17.

Moreover, the search unit 45 searches for a place where adjustment can be performed over the entire adjustment target distance range. The first search method enables search for a place suitable for adjustment.

Furthermore, the search unit 45 searches for a place where adjustment can be performed over a distance range in which the adjustment unit 6 has not performed adjustment before. The second search method enables search for a place suitable for adjustment.

Alternatively, the search unit 45 searches for a place where adjustment can be performed over a distance range wider than the adjustable distance range. The third search method enables search for a place more suitable for adjustment than the host vehicle position is.

In addition, the second display control unit 46 causes the display device 32 to display the second image when the adjustment unit 6 completes adjustment. With the processing of steps ST25a and ST26a illustrated in FIG. 14, the user can be notified of a place suitable for adjustment.

The adjustment device 100b further includes the first display control unit 31 for causing the display device 32 to display the first image indicating the adjustable distance range before the adjustment unit 6 performs the adjustment; the necessity determining unit 33 for determining necessity of the adjustment depending on operation input to the operation input device 7 in a state where the first image is displayed on the display device 32; the search unit 45 for searching for a place suitable for the adjustment in a case where the necessity determining unit 33 determines that the adjustment is unnecessary; and the second display control unit 46 for causing the display device 32 to display the second image indicating a search result by the search unit 45 in a case where the necessity determining unit 33 determines that the adjustment is unnecessary. With the system configuration illustrated in FIG. 18, the processing in steps ST25a and ST26a illustrated in FIG. 19 allows the user to be notified of a place suitable for adjustment.

The adjustment device 100b further includes: the first display control unit 31 for causing the display device 32 to display the first image indicating the adjustable distance range before the adjustment unit 6 performs the adjustment; the search unit 45 for searching for a place suitable for the adjustment before the adjustment unit 6 performs the adjustment; the second display control unit 46 for causing the display device 32 to display the second image indicating the search result by the search unit 45 before the adjustment unit 6 performs the adjustment; and the necessity determining unit 33 for determining necessity of the adjustment depending on operation input to the operation input device 7 in a state where the first image and the second image are displayed on the display device 32. With the system configuration illustrated in FIG. 18, the processing in steps ST25a and ST26a illustrated in FIG. 20 allows the user to be notified of a place suitable for adjustment. This allows the user to determine the necessity of adjustment at the host vehicle position while considering the adjustable distance range at the host vehicle position, the distance from the host vehicle position to a place suitable for adjustment, and the like.

Note that, within the scope of the present invention, the present invention may include a flexible combination of the respective embodiments, a modification of any component of the respective embodiments, or an omission of any component in the respective embodiments.

### INDUSTRIAL APPLICABILITY

An adjustment device of the present invention is applicable to a display system for vehicles.

### REFERENCE SIGNS LIST

1: vehicle, 2: transmissive display device, 3: display control unit, 4: lighting device, 5: emission control unit, 6: adjustment unit, 7: operation input device, 8: surrounding situation detecting unit, 9: camera, 10: radar, 11: sonar, 12: illuminance meter, 13: surrounding situation detecting device, 14: adjustment condition storing unit, 15: illuminance determining unit, 16: distance range detecting unit, 17: adjustment condition determining unit, 18: adjustment result storing unit, 19: storage device, 20, 20a, 20b: control device, 21: processor, 22: memory, 23: memory, 24: processing circuit, 31: first display control unit, 32: display device, 33: necessity determining unit, 41: GPS receiver, 42: wireless communication device, 43: server device, 44: map database storing unit (map DB storing unit), 45: search unit, 46: second display control unit, 100, 100a, 100b: adjustment device, 200, 200a, 200b: display system.

1. An adjustment device in which a position of a virtual image corresponding to a display image in a view outside a vehicle is adjusted by adjustment of the display image by an in-vehicle transmissive display device, the adjustment device comprising:
a processor; and
a memory storing instructions which, when executed by the processor, causes the processor to perform processes of:
performing adjustment of the display image depending on operation input to an operation input device in a state where reference light, serving as a reference for the position of the virtual image, is emitted to a road surface; and
detecting an adjustable distance range, in which the adjustment can be performed, in an adjustment target distance range set to be subjected to the adjustment,
wherein the processor performs the adjustment of the display image corresponding to the virtual image in the adjustable distance range in a state where the reference light is emitted to a road surface in the adjustable distance range.

2. The adjustment device according to claim 1,
wherein the adjustment is to bring the position of the virtual image close to a position indicated by the reference light by adjustment of a position, a size, binocular parallax, or a brightness of the display image.

3. The adjustment device according to claim 1,
wherein the processes further include:
detecting an obstacle or undulations of a road surface by using a camera, a radar, or sonar provided in the vehicle having the transmissive display device,
wherein the processor detects, as the adjustable distance range, a distance range in which the reference light is emitted on a flat road surface by using a detection result.

4. The adjustment device according to claim 1,
wherein the processes further include:
detecting an illuminance using an illuminance meter provided in the vehicle having the transmissive display device,
wherein the processor determines whether a value of the detected illuminance is within an adjustable illuminance range in which the adjustment can be performed, and
the processor performs the adjustment in a case where the value of the detected illuminance is within the adjustable illuminance range.

5. The adjustment device according to claim 1,
wherein the processor estimates an adjustment result of the display image corresponding to the virtual image outside the adjustable distance range by using an adjustment result of the display image corresponding to the virtual image within the adjustable distance range.

6. The adjustment device according to claim 1,
wherein the processes further include:
causing a display device to display a first image indicating the adjustable distance range.

7. The adjustment device according to claim 6,
wherein the processor causes the display device to display the first image before the adjustment unit performs the adjustment, and
the processes further comprise determining necessity of the adjustment depending on operation input to the operation input device in the state where the first image is displayed on the display device.

8. The adjustment device according to claim 6,
wherein the processor causes the display device to display the first image after the adjustment unit performs the adjustment.

9. The adjustment device according to claim 1,
wherein the processes further include:
searching for a place suitable for the adjustment; and
causing a display device to display a second image indicating a search result.

10. The adjustment device according to claim 9,
wherein the processor searches for a place suitable for the adjustment using information included in a map database.

11. The adjustment device according to claim 9,
wherein the processor searches for a place suitable for the adjustment using an image photographed by a camera provided in the vehicle having the transmissive display device.

12. The adjustment device according to claim 9,
wherein the processor searches for a place where the adjustment can be performed over the entire adjustment target distance range.

13. The adjustment device according to claim 9,
wherein the processor searches for a place where the adjustment can be performed over a distance range in which the adjustment unit has not performed the adjustment before.

14. The adjustment device according to claim 9,
wherein the processor searches for a place where the adjustment can be performed over a distance range wider than the adjustable distance range.

15. The adjustment device according to claim 9,
wherein the processor causes the display device to display the second image when the processor completes the adjustment.

16. The adjustment device according to claim 1,
wherein the processes further include:
causing a display device to display a first image indicating the adjustable distance range before the processor performs the adjustment;
determining necessity of the adjustment depending on operation input to the operation input device in a state where the first image is displayed on the display device;
searching for a place suitable for the adjustment in a case where the processor determines that the adjustment is unnecessary; and
causing the display device to display a second image indicating a search result in a case where the processor determines that the adjustment is unnecessary.

17. The adjustment device according to claim 1,
wherein the processes further include:
causing a display device to display a first image indicating the adjustable distance range before the adjustment unit performs the adjustment;
searching for a place suitable for the adjustment before the processor performs the adjustment;
causing the display device to display a second image indicating a search result before the processor performs the adjustment; and
determining necessity of the adjustment depending on operation input to the operation input device in a state where the first image and the second image are displayed on the display device.

18. The adjustment device according to claim 1,
wherein the transmissive display device comprises a head-up display for stereoscopic vision.

19. A display system comprising: an in-vehicle transmissive display device; and an adjustment device in which a position of a virtual image corresponding to a display image in a view outside a vehicle is adjusted by adjustment of the display image by the transmissive display device,
wherein the adjustment device includes:
a processor; and
a memory storing instructions which, when executed by the processor, causes the processor to perform processes of:
performing adjustment of the display image depending on operation input to an operation input device in a state where reference light, serving as a reference for the position of the virtual image, is emitted to a road surface, and
detecting an adjustable distance range, in which the adjustment can be performed, in an adjustment target distance range set to be subjected to the adjustment,
wherein the processor performs the adjustment of the display image corresponding to the virtual image in the adjustable distance range in a state where the reference light is emitted to a road surface in the adjustable distance range.

20. An adjustment method in which a position of a virtual image corresponding to a display image in a view outside a vehicle is adjusted by adjustment of the display image by an in-vehicle transmissive display device, the adjustment method comprising:
performing adjustment of the display image depending on operation input to an operation input device in a state where reference light, serving as a reference for the position of the virtual image, is emitted to a road surface; and
detecting an adjustable distance range, in which the adjustment can be performed in an adjustment target distance range set to be subjected to the adjustment,
performing the adjustment of the display image corresponding to the virtual image in the adjustable distance range in the step of performing the adjustment in a state where the reference light is emitted to a road surface in the adjustable distance range.
